(19) United States
(12) Patent Application Publication
(10) Pub. No.: US 2012/0076913 A1
(43) Pub. Date: Mar. 29, 2012

(54) PROCESS FOR PRODUCING SYRUP FROM A FROZEN FRUIT

(76) Inventor: Steven Murdza, St. Davids (CA)

(21) Appl. No.: 13/377,406

(22) PCT Filed: Jun. 11, 2010
(86) PCT No.: PCT/CA2010/000880

§ 371 Date: Dec. 9, 2011

(30) Foreign Application Priority Data
Jun. 11, 2009 (US) 61186104

(51) Int. Cl. A23L 2/12; A23L 2/00; A23L 2/08; A23L 2/04

(52) U.S. Cl. 426/599; 426/489; 426/655; 426/650

(57) ABSTRACT

A process for the production of syrup from an at least partially frozen fruit is described. The process involves the pressing of a frozen fruit in an environment with a temperature below freezing. Dissolved soluble solids from the juice extracted from the pressing are concentrated to generate a syrup. The syrup can be used in the food and beverage industry.

### FIELD OF THE INVENTION

The present invention relates generally to the production of a food product. More specifically, the invention relates to a process for producing a syrup from an at least partially frozen fruit, and the product resulting therefrom.

### BACKGROUND OF THE INVENTION

The development of natural agents used to enhance or alter the taste of foods has experienced steady growth over the past several decades. These flavorings come in many different forms, such as extracts, syrups and powders, and are used frequently in soda production and baked goods. There also exists an interest in developing products with unique flavors for use in gourmet cooking, high-end confectionary, and the non-alcoholic beverage industry.

Juice pressed from a frozen fruit typically has a more concentrated sugar and dissolved solid content than juice from its non-frozen counterpart. As such, the flavor profile of juice pressed from a frozen fruit can be different from the flavor profile from juice pressed from a ripe, non-frozen fruit. This is evident in the wine industry, where wine made from juice pressed from a non-frozen grape is remarkably different in taste and quality from that of late-harvest, select late-harvest, special select or Icewine, which are produced from juice pressed from a partially or completely frozen grape.

The flavor profile of the juice pressed from a frozen fruit can also be enhanced, over artificial freezing methods, by allowing the fruit to freeze naturally in the environment or on the tree or vine from which it originates. Since very specific conditions are required to permit a fruit to be frozen on the tree or vine from which it originates, limited amounts of crop can be harvested each year, thus increasing the value of juice extracted therefrom.

The flavor profile of juice extracted from a frozen fruit can be further enhanced by concentrating the sugars and dissolved solids of the juice even further to create a syrup. Traditional syrup production relies on boiling a natural source of sugar, and possibly additional sugars, to a point where the water content of the mixture is decreased and a thick syrup is left. In some instances, the boiling process causes the flavor profile of the starting material to change. Depending upon the starting material and the desired end product, the changes in the flavor profile could have a dramatic effect on the acceptance of the syrup at the consumer level.

Accordingly, there is a need in the art to develop a process that can effectively make a product that retains or enhances many of the flavours and characteristics from original fruit.

### SUMMARY OF THE INVENTION

According to an aspect of the present invention, there is provided a process for producing a syrup from an at least partially frozen fruit. The process comprising the steps of: pressing the at least partially frozen fruit in an environment with a temperature below or at freezing; extracting juice from the pressed frozen fruit; and concentrating dissolved soluble solids contained in the juice to generate the syrup.

In one embodiment of the invention, the dissolved soluble solids are concentrated by evaporating a portion of liquid contained in the juice. Preferably, vacuum evaporation is used for this purpose. Preferably, a plate evaporator can be used to evaporate a portion of liquid contained in the juice. In addition, the evaporate can be collected for further use.

In another embodiment, the juice is pasteurized prior to concentrating the dissolved soluble solids.

In another embodiment, the juice is filtered prior to concentrating the dissolved soluble solids.

In a further embodiment, the at least partially frozen fruit is harvested from the tree or vine from which the fruit originates.

In a further embodiment, the at least partially frozen fruit is artificially frozen.

In yet a further embodiment, the at least partially frozen fruit is pressed more than once.

In an additional embodiment, the concentrating step further comprises the steps of: freezing the juice in an environment with a temperature of about −35° C.; thawing the frozen juice in an environment with a temperature between 20° C. and 26° C.; and collecting the syrup.

In another embodiment, the dissolved soluble solids are concentrated by adding additional sugars to the juice until a predetermined concentration is reached.

In an embodiment, the concentration of the syrup is diluted to between 45° Brix and 75° Brix. More preferably, the concentration of the syrup is diluted to about 66° Brix.

In further embodiment, the at least partially frozen fruit is a cultivar from the vitis species or combinations thereof.

In a yet further embodiment, the at least partially frozen fruit is pressed in an environment with a temperature below −7.0 degrees Celsius. Preferably, the temperature will be below −8.0 degrees Celsius.

According to another aspect of the present invention, there is provided a product made by the process of the present invention.

### BRIEF DESCRIPTION OF THE DRAWING

These and other features, aspects and advantages of the present invention will become better understood with regard to the following description and accompanying drawings wherein:

FIG. 1 is a schematic of the process according to an embodiment of the present invention.

### DETAILED DESCRIPTION OF THE INVENTION

The following description is of a preferred embodiment by way of example only and without limitation to the combination of features necessary for carrying the invention into effect.

Although the present invention will be described with reference to grapes, it should be understood that the process can be used for most varieties of fruit. In particular, varieties that can be frozen and pressed to release the juice contained therein. For example, apples and pears would be suitable for the process of the present invention.

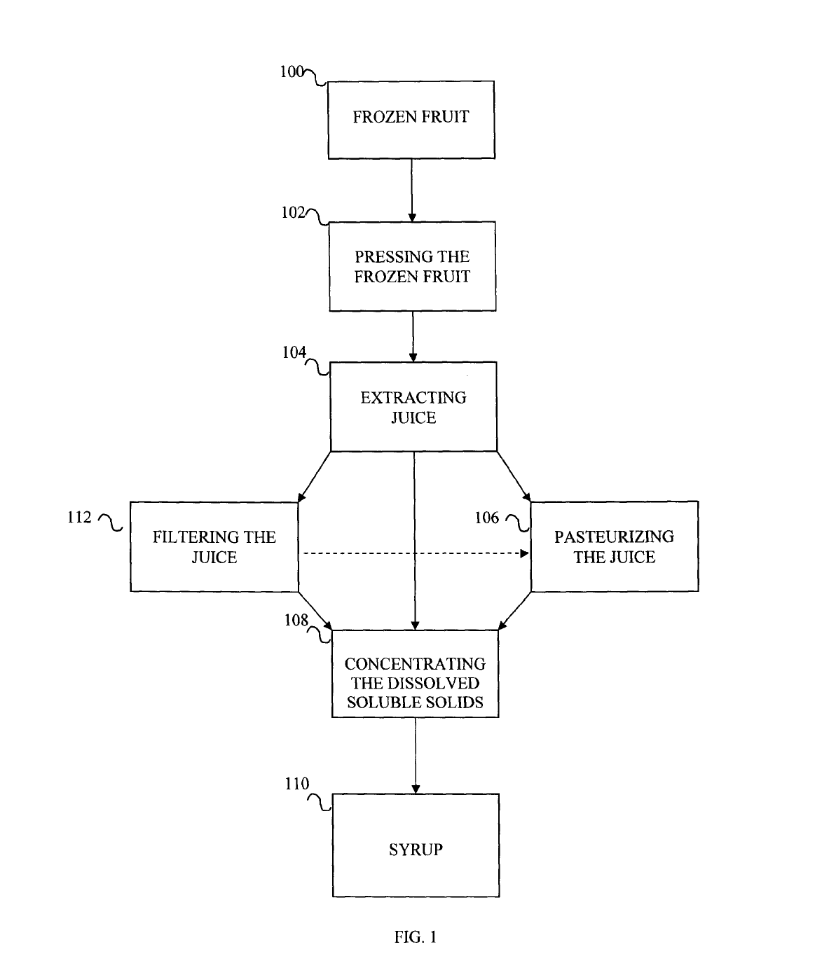

The process of the present invention, as shown in FIG. 1, produces a thick, viscous liquid, containing a large amount of dissolved sugar, but showing little tendency to deposit crystals or a syrup 110 from a partially frozen fruit 100. Although FIG. 1 shows the process as a series of discrete blocks, it should be readily understood that the various steps in the process can be carried out together or as part of a continuous process. The process comprises the steps of pressing 102 the at least partially frozen fruit 100 in an environment with a temperature at or below freezing i.e. less than or equal to zero degrees Celsius, extracting juice from the pressed frozen fruit 104; and concentrating sugars contained in the juice 108 to generate the syrup 110.

As mentioned hereinabove, most varieties of fruit can be used in the process of the present invention. In order to retain as many of the natural characteristics of the fruit as possible, it is desirable that the fruit can be frozen naturally in the environment in which it is grown. For example, by hanging the fruit in the elements and allowing the fruit to go through natural freeze-thaw cycles, the flavor profile of the end product is distinct from other products made from the same fruit. Preferably, the fruit will be frozen, or partially frozen, on the tree or vine from which it originates. For example, certain cultivars of the Vitis species of grapes, such as Riesling, Vidal, Cabernet Franc, Seyval Blanc, Chardonnay, Kerner, Gewürztraminer, Chenin Blanc, Pinot Blanc, Ehrenfelser, Merlot, Pinot Noir, Shiraz and Cabernet Sauvignon, can be frozen on the vine and harvested in a frozen state to make the syrup. Alternatively, conventional or artificial freezing methods, such as cryoextraction, can be used to freeze the fruit prior to pressing. Although it is preferred that the fruit be completely frozen before being pressed, an at least partially frozen fruit can also be used. In other words, the fruit does not have to be frozen throughout to be used in the present invention. Moreover, a single variety or combination of fruits can be used as starting material for the process.

Pressing the frozen fruit 102 will liberate or extract 104 the juice contained therein from the pomace. The temperature of the environment in which the pressing is done will dictate the dissolved soluble solid content of the resulting juice (see Ziraldo D and Kaiser K, “Icewine: Extreme Winemaking” Key Porter Books Ltd., 2007). For example, grapes pressed at −7.0 degrees Celsius will result in a juice having approximately 38° Brix. Accordingly, it is desirable to press the fruit in an environment with a temperature that is cool enough to produce a juice that has a Brix level sufficient enough to produce a syrup after the juice is concentrated. In most cases, the pressing should be done in an environment with a temperature below or near freezing i.e. about zero degrees Celsius. Preferably the fruit is harvested and pressed in a continuous process in an environment with a temperature below at least −7.0 degrees Celsius. In some applications, the fruit should be pressed in an environment of less than −8.0 degrees Celsius. The concentration of dissolved soluble solids in the juice pressed from the frozen fruit, including sugars contained therein, may be increased by lowering the temperature of the environment in which the pressing occurs. In traditional operations, the temperature in which the frozen fruit is pressed will be dictated by the temperature of the environment in which the press is housed. Alternatively, in more modern pressing machines, the temperature of the basket may be controlled.

At the end of pressing, the extracted juice 104 should have a concentration of dissolved soluble solids to water in a range that will allow for the dissolved soluble solids to be further concentrated into a syrup. For example, a dissolved soluble solid to water concentration of around 30° Brix should allow for a syrup to be produced. In some cases, the desired concentration can be achieved after a single pressing, whereas in other cases, multiple pressings may be required.

In some cases, it may be necessary or desired to filter 112 the juice after pressing to remove any potential contaminants. A plate and frame filter, as used in the wine industry, may be used for this purpose. Both square and round plate filters have been shown to be useful for this purpose. Otherwise, as the juice settles, the contaminants, such as the skins, seeds, stems, etc, will settle on the bottom of the storage vessel, thus allowing for relatively pure juice to be extracted from the top of the volume.

In some instances, the extracted juice or filtered juice may be pasteurized 106 to slow or eliminate microbial growth in the mixture. For example, the juice may be subjected to flash pasteurization to minimize the possibility of the juice being spoiled by microbial contamination.

In the next step of the process, a portion of the liquid component of the extracted juice is then removed to concentrate the dissolved soluble solids contained in the juice 108. In some cases, filtering the extracted juice prior to concentrating the dissolved soluble solids will improve or modify the resulting end product. As shown in the following examples, but not limited thereto, several different methods can be used to remove a portion of the liquid from the juice. For example, the dissolved soluble solids can be concentrated by evaporating a portion of the liquid contained in the juice. Preferably, vacuum evaporation is used for concentrating the dissolved soluble solids. Vacuum evaporation allows for the liquid to be recaptured for use as a diluent for the resulting syrup (see EXAMPLE 1).

A vacuum evaporator, such as plate evaporator, is preferably used in the process. In one embodiment, a rising/falling plate evaporator is used. In the rising/falling plate evaporator, a series of plate packs are used. Each plate pack consists of two steam plates and two product plates. In this embodiment, the first product pass is a rising pass and the second is a falling pass. The steam plates are arranged alternately between each product passage. Rising film boiling occurs as heat is transferred from the adjacent steam passage with the vapors that are produced helping to generate a thin, rapidly moving turbulent liquid film. The mixture enters the falling film pass where gravity further assists the film movement and completes the evaporation process. At the base of the falling film annulus, a rectangular duct connects all the plate units and transfers the evaporated liquor and generated vapor into a separating device.

Alternatively, the juice can be frozen and the syrup collected during thawing of the mixture (see EXAMPLE 2). Similarly, a sugar can be added to the juice until a predetermined concentration is reached (see EXAMPLE 3). It is preferable, but not an absolute requirement, that boiling not be used to concentrate the dissolved soluble solids contained in the juice, since this may change the flavor composition of the resulting syrup.

When vacuum evaporation is used to concentrate the dissolved soluble solids in the juice, the resulting evaporate or liquid can be captured and used for various purposes. For example, the evaporate can be used as a diluent for the resulting syrup, allowing for refinement of the final Brix level of the syrup. Since the evaporate retains some of the flavours and odours of the originating fruit, it can be used, among other things, in cooking or for direct consumption.

The product or syrup 110 derived from the process of the present invention can be used in cooking, as a flavoring, or as a non-alcoholic aperitif. For example, the syrup can be added to sauces or glazes or can used as a filling for chocolates or pastries. The quality and consistency of the syrup will be controlled in part by the final dissolved soluble solids to water concentration or Brix level of the syrup. The preferred concentration of the resulting syrup is at least approximately 45° Brix and 75° Brix, with the most preferred concentration being approximately 66° Brix.

### Example 1

### Vacuum Evaporation

Juice extracted from frozen grapes was concentrated by vacuum evaporation using a rising film evaporator. The system was put under vacuum, resulting in the juice being drawn through the system. Cold juice entering the system was pre-warmed to about 40° C. in seconds by passing the juice through a coil immersed in a 60° C. water bath. The warm juice then entered the rising film evaporator column, which was jacketed by water maintained at approximately 65° C. Since the vacuum lowered the boiling point of the juice, the juice boiled in the evaporator column. The product progressed up the evaporator column becoming progressively more concentrated until the desired Brix level was obtained. the product leaving the evaporator fell into a collection vessel. The water vapor removed by the evaporation process was drawn by the vacuum into another section of the apparatus where it passed through a cold condenser coil and was collected as a liquid. Enough juice, approximately 5 to 6 litres, with starting concentration of 27.2° Brix, was concentrated to produce approximately 1.6 litres of concentrate or syrup with an approximate 70.5° Brix concentration. This concentrate was divided into 300 g portions and these portions were diluted to the predetermined Brix levels of 45, 50, 55, 60 and 66 using the liquid captured in the evaporate.

### Example 2

### Freeze Concentration

Approximately 10 L of juice extracted from grapes was frozen at −35° C. in a pail. Holes were drilled in the pail to allow drainage of the syrup upon thawing. The juice was allowed to thaw at room temperature, i.e. between 20° C. and 26° C., and the material that drained out was collected. The initial 100 ml that drained from the pail measured 52° Brix. The concentration of sugar in the material drained from the pail decreased as the volume increased.

### Example 3

### Sucrose Addition

Three hundred gram portions juice obtained from frozen grapes, with a dissolved sugar concentration of 27.2° Brix, were weighed out. Enough sucrose was added to the samples to bring the Brix level up to the desired valves, i.e. 45, 50, 55, 60 and 66. The sucrose would not completely dissolve with the samples at refrigerated temperatures, particularly the high Brix samples. The samples were then placed in a 40° water bath (an stirred) for up to 30 minutes depending on the concentration of the sample. Brix levels obtained after the samples had cooled indicated that the levels of dissolved solids were still slightly lower than desired. The samples were further heated and stirred at 47° C. for up to another 30 minutes. After this step, samples were cool and the predetermined or desired sugar concentration was measured.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein set forth, and as follows in the scope of the appended claims.

1. A process for producing a syrup from an at least partially-frozen fruit, the process comprising the steps of:
(a) pressing the at least partially-frozen fruit in an environment with a temperature below or at freezing;
extracting juice from the pressed frozen fruit; and
(c) concentrating dissolved soluble solids contained in the juice to generate the syrup.

2. The process of claim 1, wherein the dissolved soluble solids are concentrated by evaporating a portion of liquid contained in the juice.

3. The process of claim 2, wherein the dissolved soluble solids are concentrated by vacuum evaporation.

4. The process of claim 3, wherein the dissolved soluble solids are concentrated by a plate evaporator.

5. The process of claim 4, wherein the dissolved soluble solids are concentrated using a rising/falling film plate evaporator.

6. The process of claim 1, further comprising pasteurizing the juice prior to concentrating the dissolved soluble solids.

7. The process of claim 1, further comprising filtering the extracted juice prior to concentrating the dissolved soluble solids.

8. The process of claim 2, further comprising collecting the evaporated juice.

9. The process of claim 1, further comprising harvesting the at least partially-frozen fruit from the tree or vine from which the fruit originates.

10. The process of claim 1, wherein the at least partially-frozen fruit is pressed more than once.

11. The process of claim 1, wherein the concentrating step further comprises:
(a) freezing the juice in an environment with a temperature of about −35° C.;
(b) thawing the frozen juice in an environment with a temperature between about 20° C. and about 26° C.; and
(c) collecting the syrup.

12. The process of claim 1, wherein the dissolved soluble solids are concentrated by adding sugars to the juice until a predetermined concentration is reached.

13. The process of claim 12, wherein the sugar concentration of the syrup is diluted to between about 45° Brix and about 75° Brix.

14. The process of claim 13, wherein the sugar concentration of the syrup is diluted to about 66° Brix.

15. The process of claim 1, wherein the syrup is diluted to a predetermined concentration.

16. The process of claim 15, wherein the sugar concentration of the syrup is diluted to between about 45° Brix and about 75° Brix.

17. The process of claim 16, wherein the sugar concentration of the syrup is diluted to about 66° Brix.

18. The process of claim 1, wherein the at least partially-frozen fruit comprises apples, pears, one or more members of the genus Vitis, or an combination thereof.

19. The process of claim 1, wherein the at least partially-frozen fruit comprises one or more members or cultivars of the genus Vitis, or any combination thereof.

20. The method of claim 1, wherein the at least partially-frozen fruit is pressed in an environment with a temperature below about −7° C.

21. The method of claim 1, wherein the fruit is at least partially frozen by natural freezing, by artificial freezing, or by cryoextraction.

22. A product made by the process of claim 1.

23. An evaporated syrup prepared by the process of claim 3.

24. The evaporated syrup of claim 23, having a sugar concentration of between about 45° Brix and about 75° Brix.

25. The evaporated syrup of claim 23, formulated as a cooking or baking additive, a flavoring agent, or a non-alcoholic aperitif.
